(19) United States
(12) Patent Application Publication
(10) Pub. No.: US 2025/0378823 A1
(43) Pub. Date: Dec. 11, 2025

(54) SPEECH RECOGNITION

(71) Applicants: Beijing Zitiao Network Technology Co., Ltd., Beijing (CN); Lemon Inc., Grand Cayman (KY)

(72) Inventors: Yizhou Lu, Beijing (CN); Lu Lu, Los Angeles, CA (US)

(21) Appl. No.: 19/233,747

(22) Filed: Jun. 10, 2025

(30) Foreign Application Priority Data
Jun. 11, 2024 (CN) 202410749708.0

(51) Int. Cl. G10L 15/08; G10L 15/22

(52) U.S. Cl. CPC G10L 15/08; G10L 15/22

(57) ABSTRACT

Embodiments of the disclosure relates to a method, an apparatus, a device and a storage medium for speech recognition. An example method provided herein includes: generating first prediction information for target speech content by using a speech recognition model based on context information; generating second prediction information for the target speech content by using the speech recognition model, the second prediction information being independent of the context information; generating mask information based on a probability of a set of candidate tokens indicated by the second prediction information, the mask information indicating that at least one candidate token in the set of candidate tokens does not match the target speech content; updating the first prediction information by using the mask information; and generating a speech recognition result for the target speech content based on the first prediction information.

### CROSS-REFERENCE

The present application claims priority to Chinese Patent Application No. 202410749708.0, filed on Jun. 11, 2024, and entitled “METHOD, APPARATUS, DEVICE AND STORAGE MEDIUM FOR SPEECH RECOGNITION”, which is incorporated herein by reference in its entirety.

### FIELD

Example embodiments of the present disclosure generally relate to the field of computer, and in particular, to speech recognition.

### BACKGROUND

With the development of computer technology, speech recognition is becoming a key technology for human-machine interfaces in information technology. Speech recognition technology is a technique for a machine to transform a speech signal into a corresponding text or command by recognizing and understanding. Accordingly, people can operate by a speech command through speech recognition. Therefore, the speech recognition technology is increasingly important in the process of human-computer interaction.

### SUMMARY

In a first aspect of the present disclosure, a speech recognition method is provided. The method includes: generating first prediction information for target speech content by using a speech recognition model based on context information; generating second prediction information for the target speech content by using the speech recognition model, the second prediction information being independent of the context information; generating mask information based on a probability of a set of candidate tokens indicated by the second prediction information, the mask information indicating that at least one candidate token in the set of candidate tokens does not match the target speech content; updating the first prediction information by using the mask information; and generating a speech recognition result for the target speech content based on the updated first prediction information.

In a second aspect of the present disclosure, an apparatus for speech recognition is provided. The apparatus includes: a first prediction information generation module configured to generate first prediction information for target speech content by using a speech recognition model based on context information; a second prediction information generation module configured to generate second prediction information for the target speech content by using the speech recognition model, the second prediction information being independent of the context information; a mask information generation module configured to generate mask information based on a probability of a set of candidate tokens indicated by the second prediction information, the mask information indicating that at least one candidate token in the set of candidate tokens does not match the target speech content; a prediction information updating module configured to update the first prediction information by using the mask information; and a result generation module configured to generate a speech recognition result for the target speech content based on the updated first prediction information.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium having a computer program stored thereon, the computer program being executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments according to the present disclosure may be implemented;

FIG. 2 illustrates a schematic diagram of an example architecture for speech recognition according to some embodiments of the present disclosure;

FIG. 3 illustrates a flowchart of an example process for speech recognition according to some embodiments of the present disclosure;

FIG. 4 illustrates a schematic structural block diagram of an apparatus for speech recognition according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

As used herein, the term “model” may learn associations between respective inputs and outputs from training data such that corresponding outputs may be generated for a given input after training is complete. The generation of the model may be based on machine learning techniques. Deep learning is a machine learning algorithm that processes inputs and provides corresponding outputs by using a multi-layer processing unit. “Model” may also be referred to herein as a “machine learning model,” “machine learning network,” or “network,” which terms are used interchangeably herein. A model may in turn include different types of processing units or networks.

As used herein, a “unit,” an “operating unit,” or a “subunit” may be composed of a machine learning model or network of any suitable structure. As used herein, a set of elements or similar expressions may include one or more such elements. For example, a “set of convolution units” may include one or more convolution units.

Embodiments of the present disclosure may relate to data of a user, acquisition and/or use of data, and the like. These aspects all follow the corresponding laws and regulations and related regulations. In the embodiments of the present disclosure, all the collection, obtainance, processing, management, forwarding and use of data are carried out on the premise that the user is aware of and confirms it. Accordingly, when implementing the embodiments of the present disclosure, the types of the data or information that may be involved, the usage scope, the usage scenario, and the like should be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, if personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function, and does not affect the basic function of the user.

The current end-to-end model usually uses a word discovery and speech technology, Weighted Finite State Transducer (WFST) biasing strategy, and only needs to interpolate and fuse scores of WFST biassing and end-to-end automatic speech recognition (ASR) models during decoding. Another strategy is to directly perform end-to-end training on the biassing module and the ASR model together (for example, a CLAS model for speech recognition based on context phrases), the candidate phrase list is encoded by an additional text encoder, the candidate word list is selected through an attention mechanism, and then the candidate word list is fused with the acoustic representation. In addition, the speech model (Whisper) based on an encoder-decoder structure directly inputs the historical decoding result as context information to the decoder side for a long audio thereby maintaining consistency of long audio decoding.

However, the current end-to-end model usually uses a decoder structure of a relatively shallow level, so that the capability of modeling the text information is relatively limited, and massive text corpus cannot be fully used.

In view of this, embodiments of the present disclosure provide a solution for speech recognition. According to the solution, first prediction information for target speech content may be generated by using a speech recognition model based on context information. Correspondingly, second prediction information for the target speech content is generated by using the speech recognition model, and the second prediction information is independent of the context information. Then, mask information is generated based on a probability of a set of candidate tokens indicated by the second prediction information, the mask information indicates that at least one candidate token in the set of candidate tokens does not match the target speech content. Then, the first prediction information is updated by using the mask information, and the speech recognition result for the target speech content is generated based on the updated first prediction information.

Therefore, the recognition is assisted through the context information in the present disclosure, and excessive attention to the context information may be avoided, and the recognition accuracy of the speech recognition model can be improved.

Various example implementations of this scheme are described in detail below in conjunction with the accompanying drawings.

### Example Environment

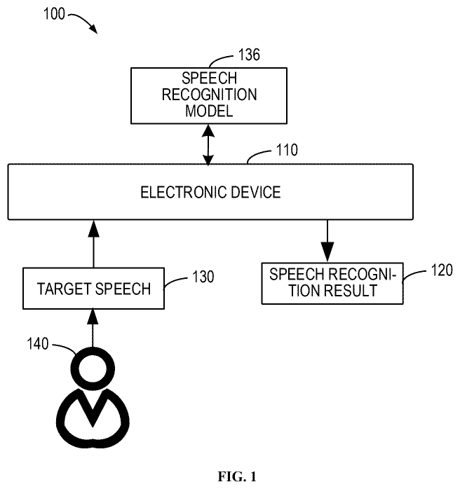

FIG. 1 illustrates a schematic diagram of an example environment 100 in which embodiments of the present disclosure can be implemented. In the environment 100, an electronic device 110 and a speech recognition model 136 are deployed. In some embodiments, the electronic device 110 receives target speech 130 from a user 140, and then the electronic device 110 invokes the speech recognition model 136 to generate a speech recognition result 120 based on the target speech 130.

In some embodiments, the speech recognition model 136 includes at least a language model, a speech encoding model, a transformer, and the like. The electronic device 110 may generate a speech feature representation by using the speech encoding model in the speech recognition model 136. The electronic device 110 generates the speech recognition result 120 based on the speech feature representation and context information by using the language model in the speech recognition model 136. In some embodiments, the speech recognition model may run on a local device or a remote device.

In some embodiments, the electronic device 110 may include various types of computing systems/servers capable of providing computing power, and the electronic device 110 may include a terminal device. Such terminal devices may be any type of mobile terminal, fixed terminal, or portable terminal, including mobile handsets, desktop computers, laptop computers, notebook computers, netbook computers, tablet computers, media computers, multimedia tablets, personal communication systems (PCS) devices, personal navigation devices, personal digital assistants (PDAs), audio/video players, digital cameras/camcorders, positioning devices, television receivers, radio broadcast receivers, electronic book devices, gaming devices, or any combination of the foregoing, including accessories and peripherals of these devices, or any combination thereof. The electronic device 110 may include, for example, various types of computing systems/servers capable of providing computing power, such as mainframes, edge computing nodes, computing devices in a cloud environment, virtual machines, and the like. Although shown as a single device, the electronic device 110 may include multiple physical devices.

It should be understood that the structures and functions of the various elements in the environment 100 are described for illustrative purposes only and do not imply any limitation to the scope of the present disclosure.

### Speech Recognition Based on Context Information

An example process for speech recognition according to embodiments of the present disclosure will be described below with reference to the accompanying drawings.

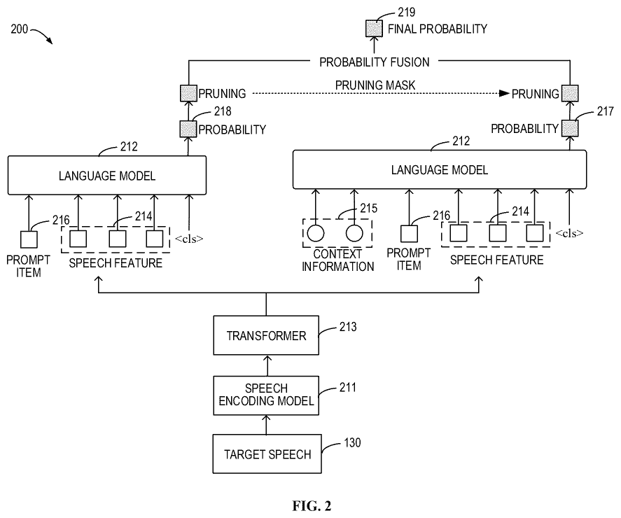

FIG. 2 shows a schematic diagram of an example architecture 200 for speech recognition according to some embodiments of the present disclosure. For ease of discussion, reference will be made to FIG. 1.

In some embodiments, the electronic device 110 generates first prediction information for target speech content by using a speech recognition model based on context information. In the example architecture 200, the electronic device 110 generates, according to the context information 215 and by using the speech recognition model 136, the first prediction information for content of the target speech 130.

In some embodiments, the speech recognition model includes a speech encoding model configured to generate a speech feature representation of the received speech content. A speech encoding model 211 is used to encode the target speech 130 into a speech feature representation 214.

In some embodiments, the speech recognition model 136 further includes a transformer 213 for transforming the speech feature representation 214 determined by the speech encoding model 211 to a dimension that the language model 212 can process, i.e., to be a speech token (also referred to as “speech embedding”).

In some embodiments, the speech recognition model further includes a language model configured to obtain model input information generated based on the speech feature representation and the associated context information. Then, the electronic device 110 obtains the language model to generate a corresponding speech recognition result according to the model input information. In the example architecture 200, the language model 212 may obtain model input information according to a prompt item 216 and based on the speech feature representation 214 and the context information 215. In some embodiments, the prompt item 216 is used to prompt the model for tasks of speech recognition.

Subsequently, the electronic device 110 generates the first prediction information (e.g., a probability 217, also referred to as logits) by using the language model 212 based on the input information. It may be understood that the first prediction information indicates a word list size, that is, the first prediction information includes a probability corresponding to each word in the word list. The first prediction information may be represented by p(yₙ|x,c,y_{<n}), where the x indicates a sequence corresponding to the target speech, the c indicates a sequence corresponding to the context information, and the n indicates the n-th step in each step of decoding. In some examples, in the process of training the speech recognition model 136, the electronic device 110 respectively inputs the sequence corresponding to the prompt item 216, the sequence corresponding to the context information, and the sequence corresponding to the target speech to the language model 212, which is taken as a condition for generating a final speech recognition output sequence y_{1, 2, . . . N}.

In some embodiments, the context information may be used to indicate at least one of the following: text content, scenario information, and object information. In some embodiments, the text content is generated according to historical speech content associated with the target speech. That is, the text content may be generated as the context information 215 according to the historical speech content associated with the target speech 130.

In some embodiments, the scenario information is used to describe a dialog scenario associated with the target speech content. For example, a session scenario associated with the current target speech 130 is taken as the context information 215. In some embodiments, the object information is used to describe at least one object associated with the target speech content. For example, in the interaction process related to the target speech 130, the user name and the name of a digital assistant involved, and the like, may be taken as the context information 215. For another example, the topic involved in the meeting scene associated with the target speech 130, a document involved, and the like may be taken as the context information 215.

It should be understood that the text content, the scenario information, the object information, and other data (including but not limited to the data itself, the acquisition or use of data) mentioned in this disclosure should follow the requirements of the corresponding laws and regulations and related regulations.

In some embodiments, the electronic device 110 generates second prediction information for the target speech content by using a speech recognition model. In some embodiments, the second prediction information is independent of the context information. It may be understood that the electronic device 110 generates the second prediction information (for example, a probability 218) by using the language model 212 included in the speech recognition model 136, based on the prompt item 216 and the speech feature representation 214 corresponding to the target speech 136. In some embodiments, the second prediction information may be represented by p(yₙ|x,y_{<n}).

Then, the electronic device 110 generates mask information according to a probability of a set of candidate tokens indicated by the second prediction information. In some embodiments, the mask information indicates that at least one candidate token in the set of candidate tokens does not match the target speech content.

In some examples, the electronic device 110 performs pruning based on the second prediction information to obtain mask information for a prune, for example, represented as m. The mask information indicates at least one candidate token in the set of candidate tokens that does not match the target speech 130. It may be understood that the electronic device 110 performs pruning based on the second prediction information, to retain the candidate token with the highest probability in the second prediction information, that is, the candidate token that matches the target speech.

In some embodiments, the electronic device 110 may take the following manner to generate the mask information. If a first probability corresponding to a first candidate token reaches a threshold, the electronic device 110 associates the first candidate token with a first mask value. In some examples, if the first probability corresponding to the first candidate token is high, a position corresponding to the first candidate token is set to 1.

The electronic device 110 may also take the following manner to generate the mask information. If a second probability corresponding to a second candidate token is less than the threshold, the electronic device 110 associates the second candidate token with a second mask value. In some examples, if the second probability corresponding to the second candidate token is low, a position corresponding to the second candidate token is set to 0.

Then, the electronic device 110 updates the first prediction information by using the mask information. In some embodiments, the electronic device 110 updates a probability corresponding to the at least one candidate token in the first prediction information to a predetermined value according to the mask information. In some examples, the electronic device 110 performs corresponding pruning on the first prediction information according to the mask information, to update the probability corresponding to the at least one candidate token in the first prediction information to a predetermined value.

In some examples, the pruned first prediction information may be represented by using the following formula: \hat{p}=(yₙ|x,c,y_{<n})=p(yₙ|x,c,y_{<n})·m. The pruned second prediction information may be represented by using the following formula: \hat{p}=(yₙ|x,y_{<n})=p(yₙ|x,y_{<n})·m.

In some embodiments, the electronic device 110 generates a speech recognition result for the target speech content according to the updated first prediction information. The electronic device 110 generates the speech recognition result 120 for the content of the target speech 130 according to the updated first prediction information.

In some embodiments, the electronic device 110 determines the first probability of the target token according to the updated first prediction information. Correspondingly, the electronic device 110 determines the second probability of the target token according to the second prediction information. Subsequently, the electronic device 110 determines decision information associated with the target token according to the first probability and the second probability. In some embodiments, the electronic device 110 determines a weighted sum of the first probability and the second probability as the decision information based on preset weight information.

In some embodiments, the electronic device 110 determines the first probability

$$\frac{λ}{λ + 1} \hat{p} ( {y}_{n} \vert x , c , {y}_{< n} )$$

of the target token according to the first prediction information \hat{p}(yₙ|x,c,y_{<n}) and the preset weight information

$$\frac{λ}{λ + 1} ,$$

where the λ is a preset fusion coefficient. The electronic device 110 determines the second probability

$$\frac{1}{λ + 1} \hat{p} ( {y}_{n} \vert x , {y}_{< n} )$$

of the target token according to the updated second prediction information \hat{p}(yₙ|x,y_{<n}) and the preset weight information

$$\frac{1}{λ + 1} .$$

The electronic device 110 takes the weighted sum of the first probability and the second probability as the decision information p_{final}:

$${p}_{final} = \frac{1}{λ + 1} \hat{p} ( {y}_{n} \vert x , {y}_{< n} ) + \frac{λ}{λ + 1} \hat{p} ( {y}_{n} \vert x , c , {y}_{< n} ) .$$

Then, the electronic device 110 generates a speech recognition result for the target speech content according to the decision information. In some examples, the electronic device 110 continues to search for the speech recognition result corresponding to the target speech 130 with the final decision information (sometimes referred to as a final probability 219).

In this way, the recognition is assisted by the context information, so that the speech recognition model has a longer context modeling capability, thereby improving the recognition accuracy of the speech recognition model.

### Example Processes

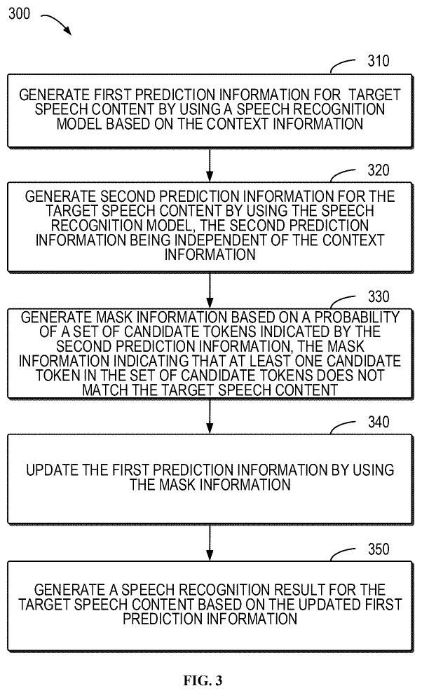

FIG. 3 illustrates a flowchart of an example process 300 for speech recognition, in accordance with some embodiments of the present disclosure. The process 300 may be implemented at the electronic device 110. The process 300 is described below with reference to FIG. 1.

As shown, at block 310, the electronic device 110 generates first prediction information for target speech content by using a speech recognition model based on context information.

At block 320, the electronic device 110 generates second prediction information for the target speech content by using the speech recognition model, the second prediction information being independent of the context information.

At block 330, the electronic device 110 generates mask information based on a probability of a set of candidate tokens indicated by the second prediction information, the mask information indicating that at least one candidate token in the set of candidate tokens does not match the target speech content.

At block 340, the electronic device 110 updates the first prediction information by using the mask information.

At block 350, the electronic device 110 generates a speech recognition result for the target speech content based on the updated first prediction information.

In some embodiments, generating the mask information based on the probability of the set of candidate tokens indicated by the second prediction information includes: associating a first candidate token with a first mask value in response to a first probability corresponding to the first candidate token reaching a threshold; or associating a second candidate token with a second mask value in response to a second probability corresponding to the second candidate token being less than the threshold.

In some embodiments, updating the first prediction information by using the mask information includes: updating, based on the mask information, a probability corresponding to the at least one candidate token in the first prediction information to a predetermined value.

In some embodiments, generating the speech recognition result for the target speech content based on the updated first prediction information includes: determining a first probability of a target token based on the updated first prediction information; determining a second probability of the target token based on the second prediction information; determining decision information associated with the target token based on the first probability and the second probability; and generating the speech recognition result for the target speech content based on the decision information.

In some embodiments, determining the decision information associated with the target token based on the first probability and the second probability includes: determining, based on preset weight information, a weighted sum of the first probability and the second probability as the decision information.

In some embodiments, the context information indicates at least one of: text content generated based on historical speech content associated with the target speech content, scenario information describing a dialog scenario associated with the target speech content, or object information describing at least one object associated with the target speech content.

In some embodiments, the speech recognition model includes a language model and a speech encoding model, the speech encoding model is configured to generate a speech feature representation of received speech content, and the language model is configured to obtain model input information generated based on the speech feature representation and associated context information, and generate a corresponding speech recognition result based on the model input information.

### Example Apparatus and Device

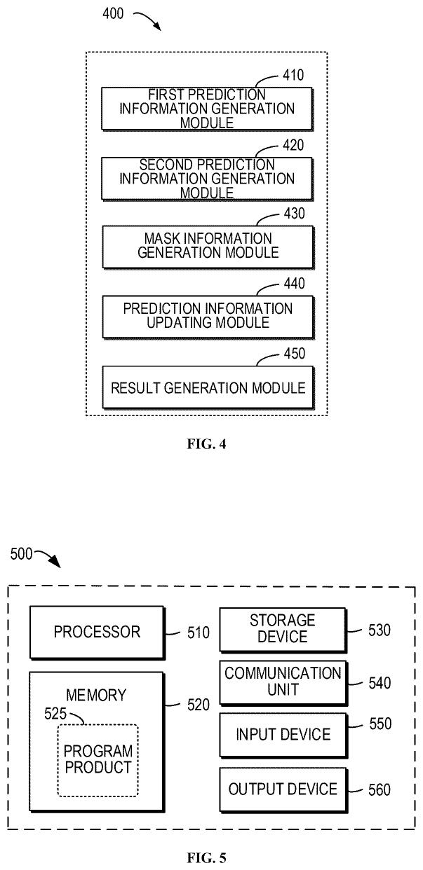

Embodiments of the present disclosure also provide a corresponding apparatus for implementing the above method or process. FIG. 4 shows a schematic structural block diagram of an apparatus 400 for speech recognition according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes a first prediction information generation module 410 configured to generate first prediction information for target speech content by using a speech recognition model based on context information. The apparatus 400 further includes a second prediction information generation module 420 configured to generate second prediction information for the target speech content by using the speech recognition model, the second prediction information being independent of the context information.

The apparatus 400 further includes a mask information generation module 430 configured to generate mask information based on a probability of a set of candidate tokens indicated by the second prediction information, the mask information indicating that at least one candidate token in the set of candidate tokens does not match the target speech content. The apparatus 400 further includes a prediction information updating module 440 configured to update the first prediction information by using the mask information. The apparatus 400 further includes a result generation module 450 configured to generate a speech recognition result for the target speech content based on the updated first prediction information.

In some embodiments, the mask information generating module 430 is further configured to associate a first candidate token with a first mask value in response to a first probability corresponding to the first candidate token reaching a threshold; or associate a second candidate token with a second mask value in response to a second probability corresponding to the second candidate token being less than the threshold.

In some embodiments, the prediction information updating module 440 is further configured to update, based on the mask information, a probability corresponding to the at least one candidate token in the first prediction information to a predetermined value.

In some embodiments, the result generation module 450 is further configured to determine a first probability of a target token based on the updated first prediction information; determine a second probability of the target token based on the second prediction information; determine decision information associated with the target token based on the first probability and the second probability; and generate the speech recognition result for the target speech content based on the decision information.

In some embodiments, the result generation module 450 further includes a decision information determination module configured to determine, based on preset weight information, a weighted sum of the first probability and the second probability as the decision information.

In some embodiments, the context information indicates at least one of: t text content generated based on historical speech content associated with the target speech content, scenario information describing a dialog scenario associated with the target speech content, or object information describing at least one object associated with the target speech content.

In some embodiments, the speech recognition model includes a language model and a speech encoding model, the speech encoding model is configured to generate a speech feature representation of received speech content; and the language model is configured to obtain model input information generated based on the speech feature representation and associated context information, and generate a corresponding speech recognition result based on the model input information.

The modules included in the apparatus 400 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processing units or processors 510, a memory 520, a storage device 530, one or more communication units 540, one or more input devices 550, and one or more output devices 560. The processor 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in one or more blocks of the flowchart(s) and/or block diagram(s).

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagram(s) and/or flowchart(s), may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

What is claimed is:

1. A method comprising:
generating first prediction information for target speech content by using a speech recognition model based on context information;
generating second prediction information for the target speech content by using the speech recognition model, the second prediction information being independent of the context information;
generating mask information based on a probability of a set of candidate tokens indicated by the second prediction information, the mask information indicating that at least one candidate token in the set of candidate tokens does not match the target speech content;
updating the first prediction information by using the mask information; and
generating a speech recognition result for the target speech content based on the first prediction information.

2. The method of claim 1, wherein generating the mask information based on the probability of the set of candidate tokens indicated by the second prediction information comprises:
associating a first candidate token with a first mask value in response to a first probability corresponding to the first candidate token reaching a threshold; or
associating a second candidate token with a second mask value in response to a second probability corresponding to the second candidate token being less than the threshold.

3. The method of claim 1, wherein updating the first prediction information by using the mask information comprises:
updating, based on the mask information, a probability corresponding to the at least one candidate token in the first prediction information to a predetermined value.

4. The method of claim 1, wherein generating the speech recognition result for the target speech content based on the first prediction information comprises:
determining a first probability of a target token based on the first prediction information;
determining a second probability of the target token based on the second prediction information;
determining decision information associated with the target token based on the first probability and the second probability; and
generating the speech recognition result for the target speech content based on the decision information.

5. The method of claim 4, wherein determining the decision information associated with the target token based on the first probability and the second probability comprises:
determining, based on preset weight information, a weighted sum of the first probability and the second probability as the decision information.

6. The method of claim 1, wherein the context information indicates at least one of:
text content generated based on historical speech content associated with the target speech content,
scenario information describing a dialog scenario associated with the target speech content, or
object information describing at least one object associated with the target speech content.

7. The method of claim 1, wherein the speech recognition model comprises a language model and a speech encoding model,
the speech encoding model is configured to generate a speech feature representation of received speech content, and
the language model is configured to obtain model input information generated based on the speech feature representation and associated context information, and generate a corresponding speech recognition result based on the model input information.

8. An electronic device comprising:
at least one processor; and
at least one memory coupled to the at least one processor and storing instructions for execution by the at least one processor, the instructions, when executed by the at least one processor, causing the electronic device to perform operations comprising:
generating first prediction information for target speech content by using a speech recognition model based on context information;
generating second prediction information for the target speech content by using the speech recognition model, the second prediction information being independent of the context information;
generating mask information based on a probability of a set of candidate tokens indicated by the second prediction information, the mask information indicating that at least one candidate token in the set of candidate tokens does not match the target speech content;
updating the first prediction information by using the mask information; and
generating a speech recognition result for the target speech content based on the first prediction information.

9. The electronic device of claim 8, wherein generating the mask information based on the probability of the set of candidate tokens indicated by the second prediction information comprises:
associating a first candidate token with a first mask value in response to a first probability corresponding to the first candidate token reaching a threshold; or
associating a second candidate token with a second mask value in response to a second probability corresponding to the second candidate token being less than the threshold.

10. The electronic device of claim 8, wherein updating the first prediction information by using the mask information comprises:
updating, based on the mask information, a probability corresponding to the at least one candidate token in the first prediction information to a predetermined value.

11. The electronic device of claim 8, wherein generating the speech recognition result for the target speech content based on the first prediction information comprises:
determining a first probability of a target token based on the first prediction information;
determining a second probability of the target token based on the second prediction information;
determining decision information associated with the target token based on the first probability and the second probability; and
generating the speech recognition result for the target speech content based on the decision information.

12. The electronic device of claim 11, wherein determining the decision information associated with the target token based on the first probability and the second probability comprises:
determining, based on preset weight information, a weighted sum of the first probability and the second probability as the decision information.

13. The electronic device of claim 8, wherein the context information indicates at least one of:
text content generated based on historical speech content associated with the target speech content,
scenario information describing a dialog scenario associated with the target speech content, or
object information describing at least one object associated with the target speech content.

14. The electronic device of claim 8, wherein the speech recognition model comprises a language model and a speech encoding model,
the speech encoding model is configured to generate a speech feature representation of received speech content, and
the language model is configured to obtain model input information generated based on the speech feature representation and associated context information, and generate a corresponding speech recognition result based on the model input information.

15. A non-transitory computer-readable storage medium having a computer program stored thereon, the computer program being executable by at least one processor to implement operations comprising:
generating first prediction information for target speech content by using a speech recognition model based on context information;
generating second prediction information for the target speech content by using the speech recognition model, the second prediction information being independent of the context information;
generating mask information based on a probability of a set of candidate tokens indicated by the second prediction information, the mask information indicating that at least one candidate token in the set of candidate tokens does not match the target speech content;
updating the first prediction information by using the mask information; and
generating a speech recognition result for the target speech content based on the first prediction information.

16. The non-transitory computer-readable storage medium of claim 15, wherein generating the mask information based on the probability of the set of candidate tokens indicated by the second prediction information comprises:
associating a first candidate token with a first mask value in response to a first probability corresponding to the first candidate token reaching a threshold; or
associating a second candidate token with a second mask value in response to a second probability corresponding to the second candidate token being less than the threshold.

17. The non-transitory computer-readable storage medium of claim 15, wherein updating the first prediction information by using the mask information comprises:
updating, based on the mask information, a probability corresponding to the at least one candidate token in the first prediction information to a predetermined value.

18. The non-transitory computer-readable storage medium of claim 15, wherein generating the speech recognition result for the target speech content based on the first prediction information comprises:
determining a first probability of a target token based on the first prediction information;
determining a second probability of the target token based on the second prediction information;
determining decision information associated with the target token based on the first probability and the second probability; and
generating the speech recognition result for the target speech content based on the decision information.

19. The non-transitory computer-readable storage medium of claim 18, wherein determining the decision information associated with the target token based on the first probability and the second probability comprises:
determining, based on preset weight information, a weighted sum of the first probability and the second probability as the decision information.

20. The non-transitory computer-readable storage medium of claim 15, wherein the context information indicates at least one of:
text content generated based on historical speech content associated with the target speech content,
scenario information describing a dialog scenario associated with the target speech content, or
object information describing at least one object associated with the target speech content.
